(19) United States
(12) Patent Application Publication
(10) Pub. No.: US 2025/0267733 A1
(43) Pub. Date: Aug. 21, 2025

(54) METHODS FOR TIME-BASED PROXIMITY DETERMINATION OF AMBIENT INTERNET OF THINGS DEVICES

(71) Applicant: APPLE INC., Cupertino, CA (US)

(72) Inventors: Ankit Bhamri, Bad Nauheim (DE); Haitong Sun, Cupertino, CA (US); Zhibin Wu, Los Altos, CA (US); Wei Zeng, San Diego, CA (US); Dawei Zhang, Saratoga, CA (US); Hong He, San Jose, CA (US); Chunxuan Ye, San Diego, CA (US); Huaning Niu, San Jose, CA (US)

(21) Appl. No.: 19/049,526

(22) Filed: Feb. 10, 2025

Related U.S. Application Data
(60) Provisional application No. 63/553,796, filed on Feb. 15, 2024.
(60) Provisional application No. 63/553,774, filed on Feb. 15, 2024.
(60) Provisional application No. 63/553,761, filed on Feb. 15, 2024.

(51) Int. Cl. H04W 76/11; G16Y 20/10; H04W 4/02

(52) U.S. Cl. CPC H04W 76/11; G16Y 20/10; H04W 4/023

(57) ABSTRACT

Systems, methods, and apparatuses for time-based proximity determination of ambient IoT devices are discussed herein. For example, a reader device may determine ambient internet of things (IoT) device groupings based on a proximity of a plurality of ambient IoT devices in relation to the reader device and may configure group identifiers (IDs) for each of the ambient IoT device groupings. Further, the reader device may transmit the group IDs to the ambient IoT devices. In some cases, the ambient IoT device may receive a carrier wave from a carrier wave node and backscatter the carrier wave such that a backscattered signal is sent to the reader device. Then, the ambient IoT device may receive, from the reader device, a group ID, wherein the group ID indicates ambient IoT device groupings based on a proximity of the ambient IoT devices in relation to the reader device.

### TECHNICAL FIELD

This application relates generally to wireless communication systems, including various ambient internet of things (IoT) devices.

### BACKGROUND

Wireless mobile communication technology uses various standards and protocols to transmit data between a base station and a wireless communication device. Wireless communication system standards and protocols can include, for example, 3rd Generation Partnership Project (3GPP) Long Term Evolution (LTE) (e.g., 4G), 3GPP New Radio (NR) (e.g., 5G), and Institute of Electrical and Electronics Engineers (IEEE) 802.11 standard for Wireless Local Area Networks (WLAN) (commonly known to industry groups as Wi-Fi®).

As contemplated by the 3GPP, different wireless communication systems' standards and protocols can use various radio access networks (RANs) for communicating between a base station of the RAN (which may also sometimes be referred to generally as a RAN node, a network node, or simply a node) and a wireless communication device known as a user equipment (UE). 3GPP RANs can include, for example, Global System for Mobile communications (GSM), Enhanced Data Rates for GSM Evolution (EDGE) RAN (GERAN), Universal Terrestrial Radio Access Network (UTRAN), Evolved Universal Terrestrial Radio Access Network (E-UTRAN), and/or Next-Generation Radio Access Network (NG-RAN).

Each RAN may use one or more radio access technologies (RATs) to perform communication between the base station and the UE. For example, the GERAN implements GSM and/or EDGE RAT, the UTRAN implements Universal Mobile Telecommunication System (UMTS) RAT or other 3GPP RAT, the E-UTRAN implements LTE RAT (sometimes simply referred to as LTE), and NG-RAN implements NR RAT (sometimes referred to herein as 5G RAT, 5G NR RAT, or simply NR). In certain deployments, the E-UTRAN may also implement NR RAT. In certain deployments, NG-RAN may also implement LTE RAT.

A base station used by a RAN may correspond to that RAN. One example of an E-UTRAN base station is an Evolved Universal Terrestrial Radio Access Network (E-UTRAN) Node B (also commonly denoted as evolved Node B, enhanced Node B, eNodeB, or eNB). One example of an NG-RAN base station is a next generation Node B (also sometimes referred to as a g Node B or gNB).

A RAN provides its communication services with external entities through its connection to a core network (CN). For example, E-UTRAN may utilize an Evolved Packet Core (EPC) while NG-RAN may utilize a 5G Core Network (5GC).

### BRIEF DESCRIPTION OF THE SEVERAL VIEWS OF THE DRAWINGS

To easily identify the discussion of any particular element or act, the most significant digit or digits in a reference number refer to the figure number in which that element is first introduced.

FIG. 1 illustrates an example of a timing-based method for a base station to determine the proximity range for ambient IoT devices, according to embodiments herein.

FIG. 2 illustrates an example of another timing based method for a base station to determine the proximity range for ambient IoT devices, according to embodiments herein.

FIG. 3 illustrates an example of another timing based method for a base station to determine the proximity range for ambient IoT devices, according to embodiments herein.

FIG. 4 illustrates different categories and specifications of ambient IoT devices, according to embodiments enclosed herein.

FIG. 5A illustrates an example of M-sequence data allocation for synchronization signal patterns in the time domain, according to embodiments disclosed herein.

FIG. 5B illustrates another example of M-sequence data allocation for synchronization signal patterns in the time domain thereof.

FIG. 5C illustrates another example of M-sequence data allocation for synchronization signal patterns in the time domain thereof.

FIG. 5D illustrates another example of M-sequence data allocation for synchronization signal patterns in the time domain thereof.

FIG. 6A illustrates an example of M-sequence data allocation for synchronization signal patterns in the time domain, according to embodiments disclosed herein.

FIG. 6B illustrates another example of M-sequence data allocation for synchronization signal patterns in the time domain thereof.

FIG. 6C illustrates another example of M-sequence data allocation for synchronization signal patterns in the time domain thereof.

FIG. 6D illustrates another example of M-sequence data allocation for synchronization signal patterns in the time domain thereof.

FIG. 7A illustrates an example of gold sequence data allocation for synchronization signal patterns in the time domain, according to embodiments disclosed herein.

FIG. 7B illustrates another example of gold sequence data allocation for synchronization signal patterns in the time domain, according to embodiments disclosed herein.

FIG. 7C illustrates another example of gold sequence data allocation for synchronization signal patterns in the time domain, according to embodiments disclosed herein.

FIG. 7D illustrates another example of gold sequence data allocation for synchronization signal patterns in the time domain, according to embodiments disclosed herein.

FIG. 8 illustrates a method for an ambient IoT device, according to embodiments herein.

FIG. 9 illustrates a method for a carrier wave node, according to embodiments herein.

FIG. 10 illustrates a method for a reader device, according to embodiments herein.

FIG. 11 illustrates an example architecture of a wireless communication system, according to embodiments disclosed herein.

FIG. 12 illustrates a system for performing signaling between a wireless device and a network device, according to embodiments disclosed herein.

### DETAILED DESCRIPTION

Various embodiments are described with regard to a UE. However, reference to a UE is merely provided for illustrative purposes. The example embodiments may be utilized with any electronic component that may establish a connection to a network and is configured with the hardware, software, and/or firmware to exchange information and data with the network. Therefore, the UE as described herein is used to represent any appropriate electronic component.

Additionally, embodiments herein are described with regard to Internet of Things (IoT) devices. Reference to an IoT device is merely provided for illustrative purposes, and the embodiment herein may be utilized with any device that have the capability to collect and exchange data. IoT devices may be embedded with sensors, software, and network connectivity, allowing them to communicate with other devices and systems. IoT devices can vary in size, complexity, and functionality. They can range from small, simple devices such as temperature sensors and smart home appliances to more complex devices like industrial machinery and autonomous vehicles.

Some IoT devices include ambient IoT devices. An ambient IoT device is a device that is able to harvest energy from ambient sources. For example, some ambient IoT devices may use radio frequency (RF) waves for power. To power such devices using RF, embodiments herein provide enhancements to a wireless communication system framework to introduce a new category of device(s) that is able to harvest energy from ambient sources. An ambient IoT device may be referred to as an RF powered device. An ambient IoT device may also be a UE device.

There may be multiple types of ambient IoT devices that the wireless communication system may support. For instance, in terms of energy storage, some devices may be battery-less devices with no energy storage capability at all, and completely dependent on the availability of an external source of energy. Some devices may include limited energy storage capability that do not need to be replaced or recharged manually, but can be charged by harvesting energy from ambient sources. In some embodiments, device categorization may be based on characteristics corresponding to a device (e.g., energy source, energy storage capability, passive/active transmission, etc.).

Embodiments herein consider the following set of ambient IoT devices. A first device type, (Device 1) may operate with around one microwatt (μW) peak power consumption, have energy storage, have an initial sampling frequency offset (SFO) up to 10λ parts per million (ppm) (e.g., 105 ppm), and provide neither downlink (DL) nor uplink (UL) amplification. The first device type's UL transmission is backscattered on a carrier wave provided externally. For instance, a device may not generate its own active transmission, and reflect or backscatter an incoming signal (carrier wave).

A second device type (Device 2a) may operate with up with a peak power consumption of up to a few hundred μW, have energy storage, have an initial SFO up to 10λ ppm, and provide both DL and/or UL amplification in the second device. The second device type's UL transmission is backscattered on a carrier wave provided externally.

A third device type (Device 2b) may operate with up with a peak power consumption of up to a few hundred μW, have energy storage, have an initial SFO up to 10λ ppm, and provide both DL and/or UL amplification in the third device. The third device type's UL transmission may be generated internally by the device.

Note that downlink in ambient IoT may be referred to as reader to device (R2D) and the channel for the R2D may be referred to as physical reader to device channel (PRDCH). Uplink in ambient IoT may be referred to as device to reader (D2R) and the channel for the D2R may be refed to as physical device to reader channel (PDRCH). Further details are provided in, for example, 3GPP technical report (TR) 38.769.

One key for all device categories is that the devices should have very low complexity and can rely on the harvested energy for transmission and reception. Additional ambient IoT device details for device categories and complexity are provided in, for example 3GPP RP-234058.

The following disclosure considers at least two deployment scenarios and two topologies. A first case can be a first deployment scenario with a first topology (base station to device). Within the first case, the base station can be indoor and the ambient IoT device can also be indoor. Furthermore, the first case can include the only direct connectivity between base station and ambient IoT device. Additionally, the base station and coexistence characteristics: Micro-cell, co-site can be included. Further, embodiments herein may be equally applicable for various deployment scenarios such as outdoor deployments and indoor deployments for the reader and/or the device.

According to the following disclosure, the second case can include a second deployment scenario with a second topology. Within the second case, the base station can be outdoors and the ambient IoT device can also be indoors, while an intermediate node (e.g., a carrier wave node) can be indoors. Furthermore, the second case can include connectivity between base station and ambient IoT device via the intermediate node (e.g., a UE). Additionally, the base station and coexistence characteristics such as micro-cell and/or co-site characteristics can be included. In some examples, the current requirement for coverage range is 10-50 milliseconds (ms) for the above topologies and deployment scenarios.

Additionally, it may be beneficial to locate the ambient IoT devices and determine ambient IoT device location information. For example, it may be beneficial to use ambient IoT device location information as to improve ambient IoT operation (e.g., by A-IoT CN sending a Command to one or more readers (e.g., the last reader(s)) associated to the device rather than sending it blindly), or to provide location information to the consumer of the ambient IoT service. Further, locating ambient IoT device(s) at a reader ID granularity may be useful to improve ambient IoT operation. Additionally, it may be beneficial to determine the proximity or ambient IoT devices. For example, proximity determination may be feasible if the reader successfully receives a device-to-reader (D2R) transmission from the device in response to a reader-to-device (R2D) transmission and the device is determined as near to the reader. Proximity determination may be feasible if the reader successfully receives a D2R transmission from the device in response to a R2D transmission and the device is determined as near to the reader based on measurements at the reader side.

In some wireless communication mechanisms, it may be beneficial to determine the proximity of the ambient IoT device. For the base station to determine which device should be considered or not for communication at a given time, it may be beneficial for the base station to determine how close or far (i.e., the proximity of) the ambient IoT device is. For example, the intended DL signals and/or externally generated carrier wave may be intended only for ambient IoT devices in close proximity, while distant ambient IoT devices are not intended for a communication. This can be beneficial for reducing the contention and unnecessary collisions among ambient IoT devices, especially before a dedicated link is established between the base station and the ambient IoT device.

Embodiments herein introduce methods and signaling framework(s) for a base station to determine the proximity range for ambient IoT devices that may try to communicate/respond to the base station. Considerations are made for both topology 1 and topology 2 and both low-category and higher category device types. Additionally, embodiments herein introduce details on how a base station may determine proximity based on, for example, timing based methods.

In some embodiments, the ambient IoT device can be configured with a backscatter mode to assist the reader (e.g., base station or UE or intermediate node) for proximity/range determination. In some cases, in the backscatter mode, the ambient IoT device can be expected to receive unmodulated carrier wave and reflect back carrier wave encoded with device ID. In one embodiment, if the ambient IoT device is capable of amplification (e.g., high category device), the device may not be expected to amplify the backscatter signal when configured with backscatter mode.

In some embodiments, if the ambient IoT device is capable of amplification (e.g., high category device), then the device may amplify (with default/pre-configured factor) the backscattered signal when configured with the backscatter mode. In response to the reflected/backscatter signal, the reader can measure the round trip time (RTT) delay, i.e., the time difference between the start of transmission of carrier wave from reader and reception of the reflection of that transmission from the ambient IoT device.

In some embodiments, the default mode of operation for an ambient IoT device can be backscatter mode unless explicitly indicated. In other embodiments, the ambient IoT device may need to be implicitly/explicitly signaled to operate in backscatter mode (i.e., transition into/change to the backscatter mode).

In some embodiments, the reader may broadcast a signal to ambient IoT devices with activation of backscatter mode, e.g., via a group cast downlink control information (DCI) or via a medium access control control element (MAC CE). Additionally, the reader may indicate the time resources for which the backscatter mode is applied including the starting time when the backscatter mode is activated, and the duration for which the backscatter mode is active. In the case of periodic configuration, a periodicity can be additionally signaled.

In one embodiment, a pre-configuration can be provided to ambient IoT devices and the signaling may trigger/activate the pre-configuration and based on the pre-configuration, the ambient IoT device can determine the time resource of the backscatter mode. In cases of multiple pre-configurations, the reader may indicate/activate/trigger one or more of, for a first pre-configuration a first time-offset value and a first time duration value, for a second pre-configuration a second time-offset value and a second time duration value, and/or for a third pre-configuration a first period value, a third time-offset value, and a third time duration value.

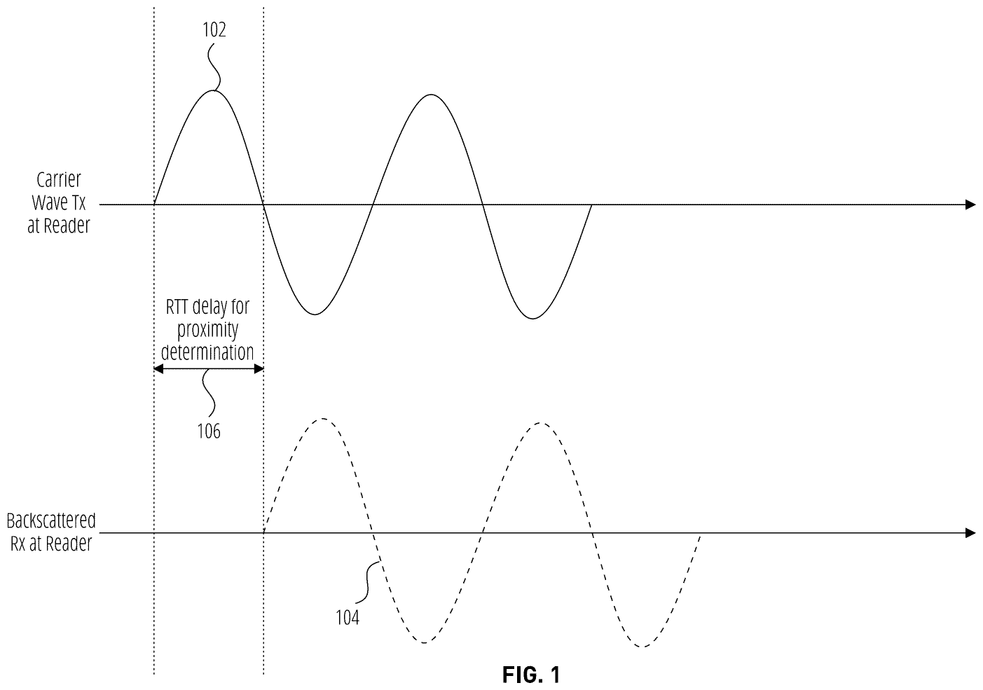

FIG. 1 illustrates an example of a timing-based method for a base station to determine the proximity range for ambient IoT devices, according to embodiments herein.

In some embodiments, an intermediate node may be configured by, for example, a base station to transmit one or more carrier waves 102 to ambient IoT devices and also to receive the backscattered signal 104 from the devices for determining the proximity/range of devices at the intermediate node itself. In some cases, the intermediate node may measure the RTT delay 106 for the devices. The RTT delay 106 may be understood as the delay between when a device transmits the carrier wave 102 and when the backscattered signal 104 is received by the device. Further, the RTT delay 106 may be used to determine the range/proximity of the ambient IoT devices.

In some embodiments, upon determining the proximity/range of the ambient IoT devices, the intermediate node may be configured to transmit the information to the reader. In one embodiment, an explicit range/proximity for each device is indicated to the reader by the intermediate node.

In at least one embodiment, the intermediate node may group multiple devices across different ranges and indicate the groupings to the reader. A first group can be defined as Group 1 (range 0-10 meters (m)): Device identifier (ID) 1, Device ID 2. A second group can be defined as Group 2 (range 10-20 m): Device ID 6, Device ID 4, and at least a third group can be defined as Group 3 (20-30 m): Device ID 3, Device ID 5. In some embodiments, the reader may determine the end-to-end proximity of the device by additionally determining the position/range/proximity of the intermediate node relative to itself.

In some embodiments, an intermediate node can be configured by the base station to transmit multiple instances of the carrier wave to ambient IoT devices and also to receive the corresponding backscattered signal from the devices for determining the proximity/range of devices at the intermediate node itself.

In at least one example, the intermediate node may measure the RTT delay for the devices from which the backscattered signal is received for each instance and calculates average RTT delay for multiple instances for each device ID and based on the average RTT delay. This can enable the intermediate node to determine the proximity/range for each device ID.

In some embodiments, the intermediate node is configured by the base station to transmit carrier wave to ambient IoT devices, receive the backscattered signal from the devices and forward the backscattered signal to the reader and determine the proximity range of the ambient IoT device based on end-to-end RTT delay.

In at least one embodiment, the reader may account of additional delay at the intermediate node if a delay can be beneficial to processing. In this embodiment, the intermediate node can receive a configuration from the reader for transmitting/forwarding carrier wave to device from reader and receiving/forwarding backscattered signal from ambient IoT device back to reader. Different configurations may include various time resources such as time offset, time duration, periodicity (if any) and/or carrier wave configuration such as numerology, frequency range, etc.

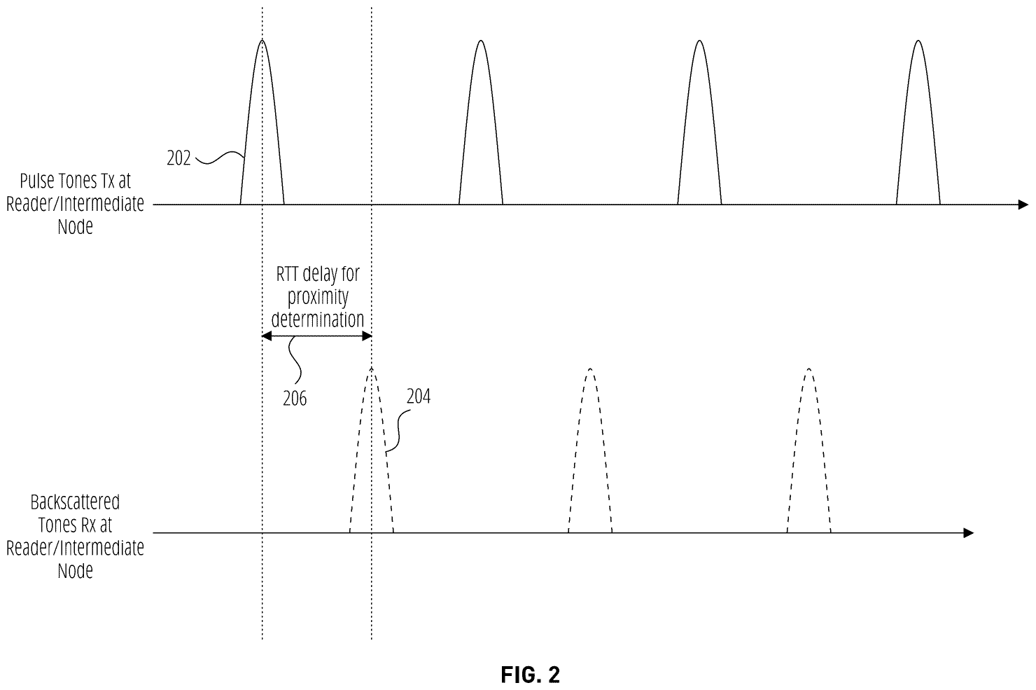

FIG. 2 illustrates an example of another timing based method for a base station to determine the proximity range for ambient IoT devices, according to embodiments herein.

In some embodiments, for proximity determination, the reader may directly transmit a short pulse waveform 202 (e.g., pulse tones), where an extremely short duration of pulse is sent within a certain duration and the backscattered wave from the ambient IoT device is a shifted short pulse waveform 204 of the short pulse waveform 202. In at least one embodiment, a gap of the shifted short pulse waveform 204 is shorter than the next short pulse, as illustrated in FIG. 2. In some examples, the shifted short pulse waveform 204 gap can be used to determine the RTT delay 206 for proximity determination.

In some embodiments, for proximity determination, the reader device may configure one or multiple intermediate node (e.g. UEs) to transmit short pulse waveforms 202 to ambient IoT devices, where an extremely short duration of a pulse is sent within a certain duration and the backscattered wave from the ambient IoT device is a shifted short pulse waveform 204 of the short pulse waveform 202. In some embodiments, a gap of the shifted short pulse waveform 204 is shorter than the next short pulse. In one embodiment, the reader may configured different intermediate nodes with different timings to transmit the short pulse waveforms 202.

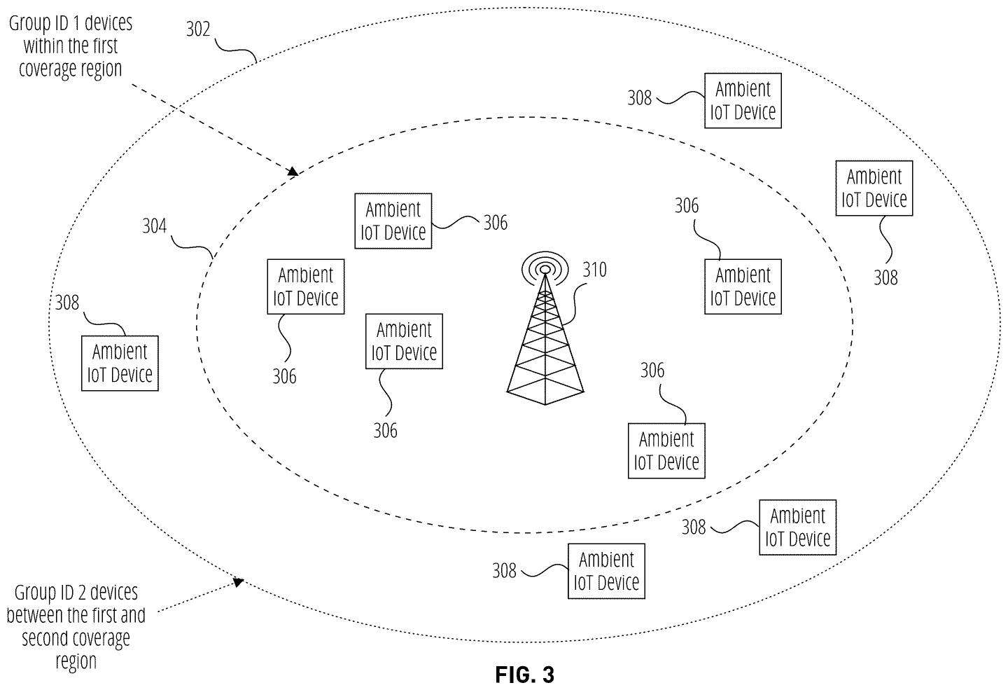

FIG. 3 illustrates an example of another timing based method for a base station to determine the proximity range for ambient IoT devices, according to embodiments herein.

In some embodiments, the reader may configure and signal one or more group IDs to the ambient IoT devices based on the proximity range determined either by the reader and/or the intermediate node. For example, various ambient IoT devices 306 within a first coverage region of the base station 310 (i.e., proximity range) may be assigned to a first group ID 304. Various other ambient IoT devices 308 within a second coverage region of the base station 310 (i.e., proximity range) may be assigned to a second group ID 302. Note that in some examples, the second coverage region does not also include the ambient IoT devices of the first coverage region.

Upon configuration of the group IDs, the ambient IoT device may communicate with the reader device when corresponding group ID devices are triggered, otherwise, it may not be expected to respond. In at least one embodiment, if the reader and/or the ambient IoT devices are moving, then the group ID may be updated for a device depending on future proximity range determination.

### Synchronization Signal Design for Ambient IoT Devices

There may be multiple types of ambient IoT devices that the wireless communication system may support. For instance, in terms of energy storage, some devices may be battery-less devices with no energy storage capability at all, and completely dependent on the availability of an external source of energy. Some devices may include limited energy storage capability that do not need to be replaced or recharged manually, but can be charged by harvesting energy from ambient sources. In some embodiments, device categorization may be based on characteristics corresponding to a device (e.g. energy source, energy storage capability, passive/active transmission, etc.).

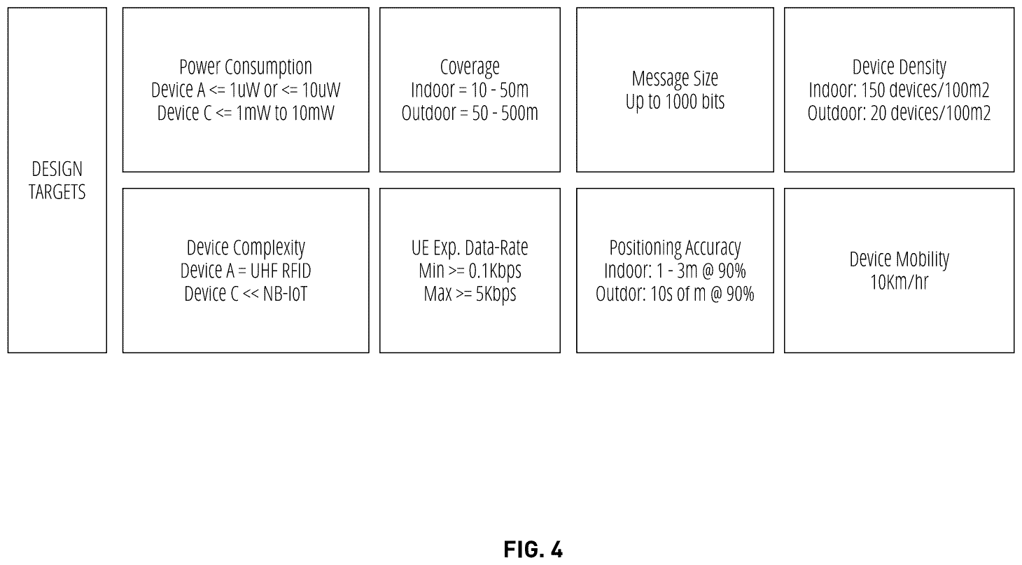

For example, FIG. 4 illustrates a table of design targets for an example set of IoT device types. As shown, some embodiments may include IoT device type A, IoT device type B and IoT device type C. IoT device type A may include no energy storage, harvests energy from ambient sources, and has no independent signal generation, but only backscattering transmission. IoT device type B may have energy storage and may harvest energy from ambient sources, but does not perform independent signal generation, i.e. only backscattering transmission. IoT device type B's use of stored energy can include amplification for backscattered signals. IoT device type C may have energy storage from harvesting ambient sources, and has independent signal generation (e.g., active RF component for transmission). Common aspects for all these device categories is that they have may have very low complexity and can rely on the harvested energy for transmission and reception. From a wireless communication system perspective, RF energy harvesting may be considered. For example, the devices may utilize the energy of the incoming signals from other nodes in the system.

Other aspects of the design targets for example IoT devices is shown in FIG. 4. For example, there may be specific targets for power consumption, coverage, message size, device density, device complexity, data-rate, positioning accuracy, and device mobility. These illustrate example design targets. Design targets may vary based on actual implantation.

For example, in some embodiments, ambient IoT devices may be categorized into different groups: lower-category IoT devices, and higher-category IoT devices. The lower-category may include devices between type A and type B from the previously described categorization. For example, the lower-category devices may have about 1 μW peak power consumption, energy storage but neither downlink nor uplink amplification in the device, and initial sampling frequency offset (SFO) can be up to thousands of ppm. Further, the device's uplink transmission may be backscattered on a carrier wave provided externally

In some embodiments, higher-category devices may include devices between type B and type C from the previously described categorization. For example, the higher-category devices may have less than or equal to a few hundred μW peak power consumption. Further, the higher-category devices may have energy storage and both downlink and/or uplink amplification. The initial SFO may be up to thousands of ppm for the higher-category devices. The higher-category device's uplink transmission may be generated internally by the device, or be backscattered on a carrier wave provided externally.

Both lower-category IoT device and higher-category IoT device categories may have very low complexity. Further, the IoT devices in both categories can rely on the harvested energy for transmission and reception. These qualities may facilitate mass deployment and increased scalability. However, the lower complexity of the IoT devices and the number of devices may lead to issues with coverage.

The current disclosure considers the design of synchronization signal block (SSB) for ambient IoT devices considering all the three categories, specifically for synchronization signal. Additional consideration of SSB for various types and/or categories of ambient IoT devices, specifically for synchronization signals. In 3GPP NR, SSB is design to serve different scenarios ranging from Enhanced Mobile Broadband (eMBB) services to Ultra-Reliable Low-Latency (URLLC) and also for multiple purposes including initial access, Radio Resource Management (RRM) measurements, beam acquisition, and other purposes.

However, in some current wireless communication systems, directly applying the current SSB design can be challenging for ambient IoT devices with low complexity and low power criteria. Therefore, embodiments herein consider and propose solutions for the following aspects: synchronization signal sequence type, synchronization signal sequence length, synchronization signal sequence mapping, and synchronization signal sequence generation.

In at least one embodiment of the present disclosure, the synchronization signal for ambient IoT devices can be composed for M-sequence. In some embodiments, M-sequences included within the synchronization signal can include bits of data. These bits of data can be mapped to resource elements, symbols, and resource blocks.

In at least one embodiment, M-sequences included within the synchronization signal can have a length of 7 bits. In some embodiments, an M-sequence with a length of 7 bits can be mapped to 7 separate REs within a single RB over 1 symbol in the time domain. In another embodiment, the synchronization signal can include M-sequences with a length of 15 bits. In this embodiment, an M-sequence with a length of 15 bits can be mapped to 15 separate REs within two contiguous RBs over a single symbol in the time domain.

In some embodiments of the present disclosure, the synchronization signal can include M-sequences that can be mapped modulated with binary phase shift keying (BPSK). BPSK can be defined as the modulation of a carrier signal by shifting the phase 180 degrees in order to denote a binary transmission. This can provide an ambient IoT device with a simple and efficient way to map the gold sequences of a synchronization signal. BPSK can be ideal for ambient IoT devices with low complexity and/or low power consumption criteria.

In at least one embodiment, the synchronization signal can include M-sequences that can be mapped modulated with amplitude shift keying (ASK). ASK can be defined as another signal modulation technique that can manipulate the amplitude of a carrier signal that can encode binary transmissions. Similar to BPSK, ASK can also provide an ambient IoT device with a simple and efficient way to map the gold sequences present in synchronization signal. ASK can be an ideal method of modulation for ambient IoT devices with low complexity and/or low power consumption criteria.

In some embodiments, BPSK is used for type C and/or type B only, while for type A and/or type B, ASK is used.

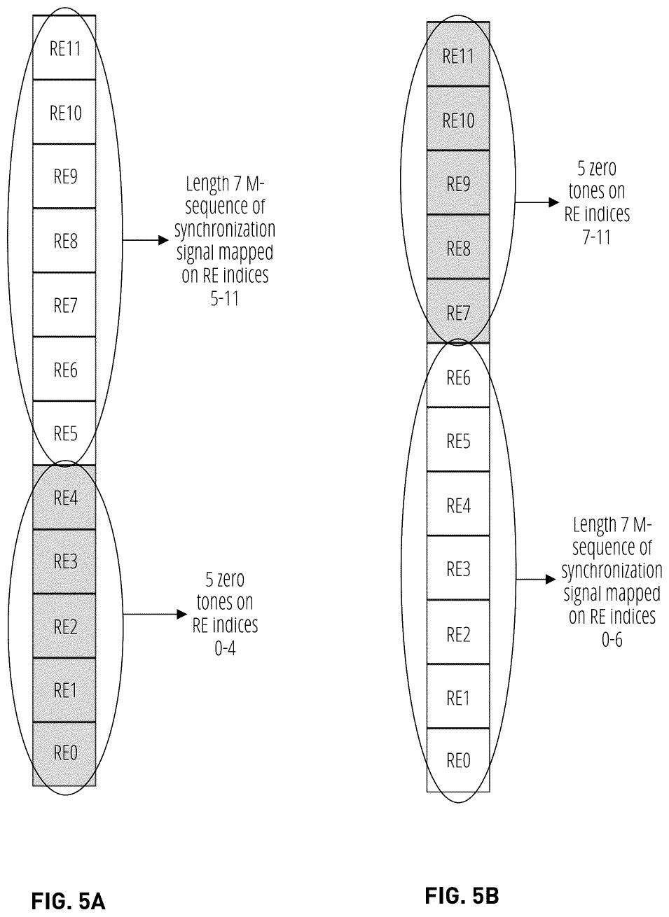

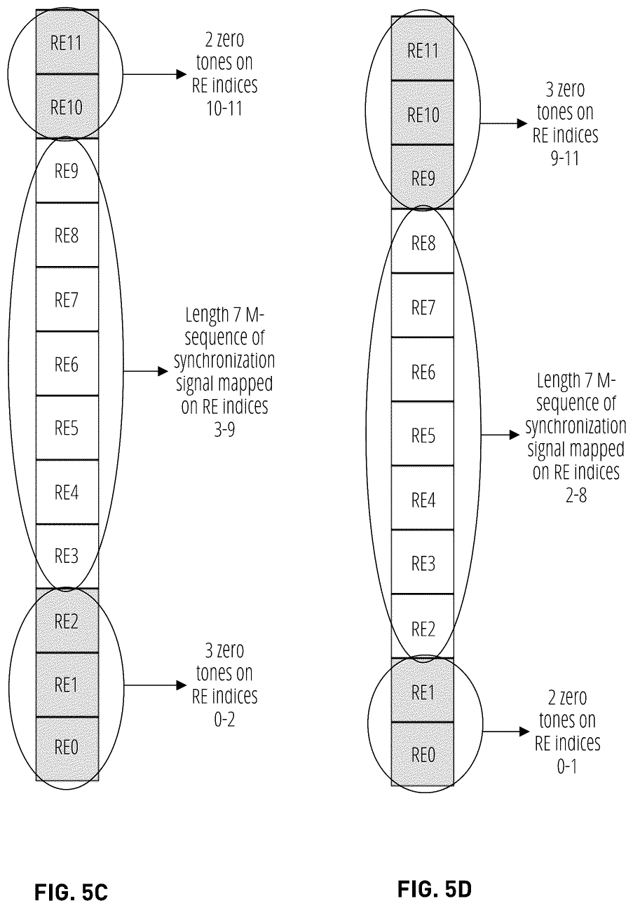

FIG. 5A through FIG. 5D show various examples of synchronization signal patterns in the time domain in accordance with one or more embodiments of the present disclosure. Specifically, the illustrated embodiments show cases of length 7 M-sequence, 1 RB over which synchronization signal is mapped, has 5 zero tones, i.e. no transmission/energy on 5 of the REs.

In at least some embodiments, the synchronization signal can include an M-sequence with a length of 7 bits. This M-sequence can be mapped within a single RB over which the synchronization signal is mapped. In at least one embodiment, this RB can include 5 REs that can be zero tones. Zero tones can be an RE that is not occupied with transmission and/or energy data. In some embodiments, the remaining 7 REs of the RB can be allocated with various data for ambient IoT devices. In at least one embodiment, these 7 REs not specified as zero tones can be configured to hold the different bits of an M-sequence. As seen in FIGS. 2A-2D, the Re indices increase in the upwards direction.

FIG. 5A shows an example of the allocation of M-sequence data and zero tones mapped over a single symbol in the time domain. In this embodiment, the first 5 lowest index REs within the one RB can be zero tones. The remaining 7 REs can be configured to hold the M-sequence data. In this embodiment, each of the remaining 7 REs can be configured to hold a single bit from the M-sequence data.

FIG. 5B shows an example of the allocation of M-sequence data and zero tones mapped over a single symbol in the time domain. In this embodiment, the last 5 highest index REs within one RB can be zero tones. The remaining 7 REs can be configured to hold the M-sequence data. In this embodiment, each of the remaining 7 REs can be configured to hold a single bit from the M-sequence data.

FIG. 5C shows an example of the allocation of M-sequence data and zero tones mapped over a single symbol in the time domain. In this embodiment, the first 3 lowest index REs and the last 2 highest index REs within one RB have zero tone. The remaining 7 REs can be configured to hold the M-sequence data. In this embodiment, each of the remaining 7 REs can be configured to hold a single bit from the M-sequence data.

FIG. 5D shows an example of the allocation of M-sequence data and zero tones mapped over a single symbol in the time domain. In this embodiment, the first 2 lowest index REs and the last 3 highest index REs within the one RB have zero tone. The remaining 7 REs can be configured to hold the M-sequence data. In this embodiment, each of the remaining 7 REs can be configured to hold a single bit from the M-sequence data.

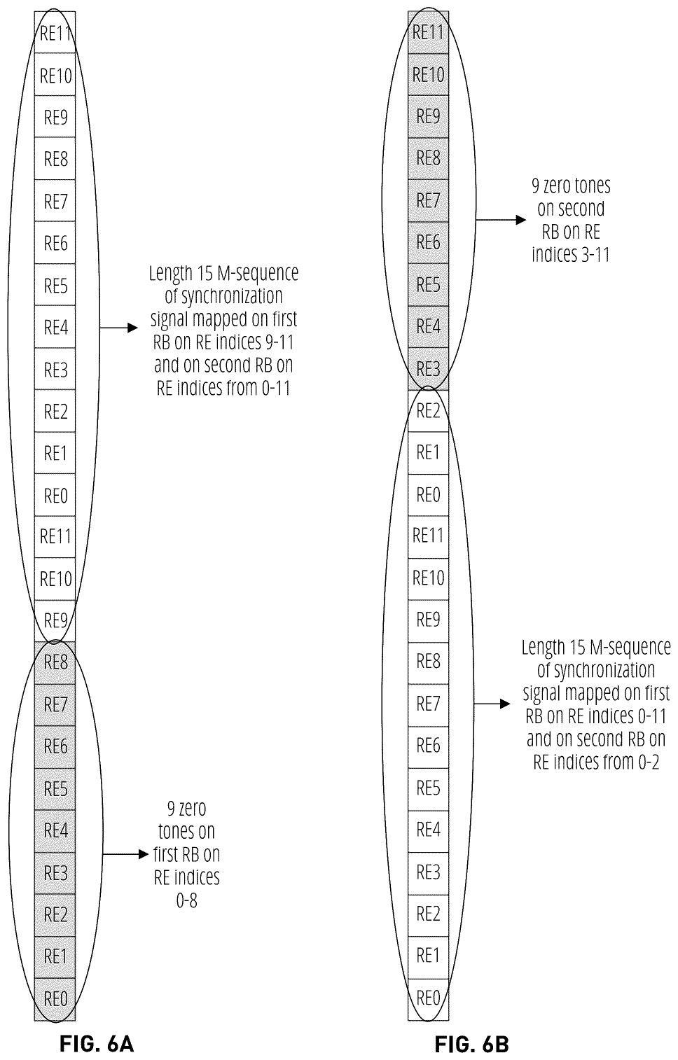

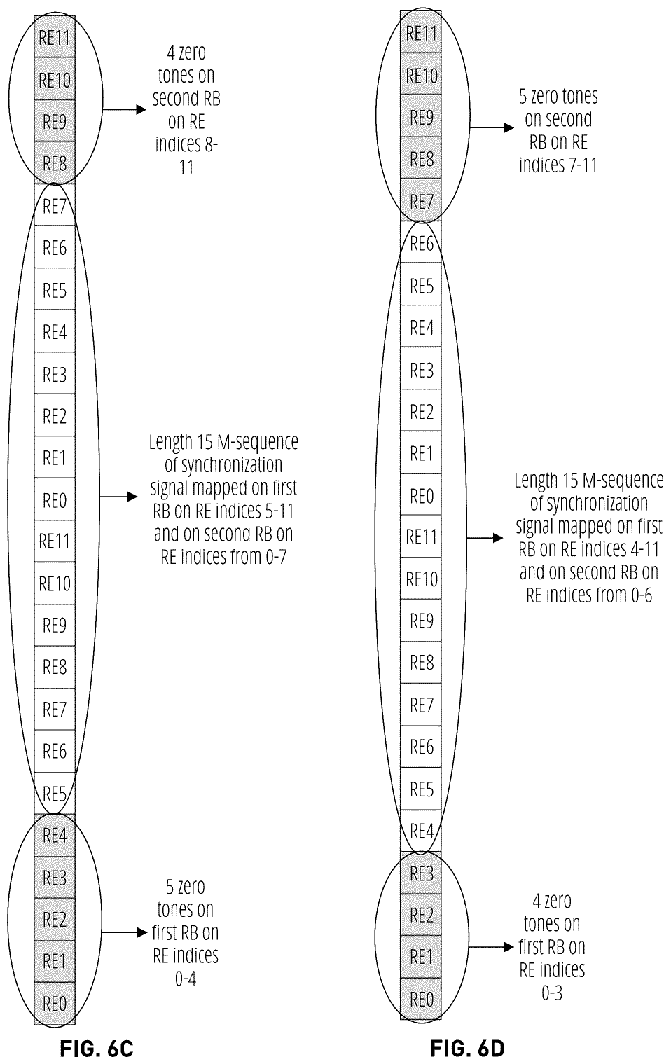

FIG. 6A through FIG. 6D show more examples of synchronization signal patterns in the time domain in accordance with one or more embodiment of the present disclosure. In embodiments of length 15 M-sequence, 2 RBs over which synchronization signal is mapped, has 9 zero tones, i.e. no transmission/energy on 9 of the REs.

In at least one embodiment, the combination of 2 RBs can enable each symbol in the time domain to hold up to 24 bits of data instead of just 12 bits if associating a single RB with a single symbol. In such embodiments, each symbol can include 9 REs that can be zero tones. In some embodiments, the remaining 15 REs of the 2 RBs can be allocated with various data for ambient IoT devices. In at least one embodiment, these 15 REs not specified as zero tones can be configured to hold the different bits of an M-sequence. As seen in FIGS. 3A-3D, the RE indices increase in the upwards direction.

FIG. 6A shows an example of the allocation of M-sequence data and zero tones mapped over a single symbol in the time domain. In this embodiment, the first 9 lowest index REs within (first) lowest RB have zero tone. The remaining 15 REs can be configured to hold the M-sequence data. In this embodiment, each of the remaining 15 REs can be configured to hold a single bit from the M-sequence data.

FIG. 6B shows an example of the allocation of M-sequence data and zero tones mapped over a single symbol in the time domain. In this embodiment, the last 9 highest index REs within (second) highest RB have zero tone. The remaining 15 REs can be configured to hold the M-sequence data. In this embodiment, each of the remaining 15 REs can be configured to hold a single bit from the M-sequence data.

FIG. 6C shows an example of the allocation of M-sequence data and zero tones mapped over a single symbol in the time domain. In this embodiment, first 5 lowest index REs within (first) lowest RB and last 4 highest REs within (second) highest RB have zero tone. The remaining 15 REs can be configured to hold the M-sequence data. In this embodiment, each of the remaining 15 REs can be configured to hold a single bit from the M-sequence data.

FIG. 6D shows an example of the allocation of M-sequence data and zero tones mapped over a single symbol in the time domain. In this embodiment, the first 4 lowest index REs within (first) lowest RB and last 5 highest REs within (second) highest RB have zero tone. The remaining 15 REs can be configured to hold the M-sequence data. In this embodiment, each of the remaining 15 REs can be configured to hold a single bit from the M-sequence data.

In at least one embodiment of the present disclosure, the number of synchronization signal sequences can be vary between different types of ambient IoT devices. In one embodiment, the same synchronization signal sequence can be used for all types and categories of ambient IoT devices. In another embodiment, the same synchronization signal sequence can be used for an ambient IoT device of type A and an ambient IoT device type B, where a different sequence can be used for a type C ambient IoT device. Further, different synchronization signal sequences can be used for each type of ambient IoT device. For example, 3 different synchronization signal sequences can be used depending on which ambient IoT device is currently applied for use in the communication system.

In some embodiments of the present disclosure, synchronization signal sequences can be generated for various ambient IoT devices. In some embodiments for sequence generation for ambient IoT devices, when same sequence of length 7 used is for all ambient IoT device categories, then sequence can be generated as:

$$synchronization signal ( n ) = 1 - 2 x ( m ) \\ m = ( n ) mod 7 \\ 0 \leq n < 7 \\ x ( i + 3 ) = ( x ( i + 1 ) + x ( i ) ) mod 2 \\ [ \begin{matrix}x ( 2 ) & x ( 1 ) & x ( 0 )\end{matrix} ] = [ \begin{matrix}1 & 1 & 1\end{matrix} ]$$

In some embodiments for sequence generation for ambient IoT devices, when same sequence of length 15 used is for all ambient IoT device categories, then sequence can be generated as:

$$synchronization signal ( n ) = 1 - 2 x ( m ) \\ m = ( n ) mod 15 \\ 0 \leq n < 15 \\ x ( i + 4 ) = ( x ( i + 2 ) + x ( i ) ) mod 2 \\ [ \begin{matrix}x ( 2 ) & x ( 1 ) & x ( 0 )\end{matrix} ] = [ \begin{matrix}1 & 1 & 0 & 1\end{matrix} ]$$

In some embodiments, the same synchronization signal sequence with a length of 7 bits can be used for type 1 and type 2 ambient IoT device categories and a different synchronization signal sequence with a length of 7 bits can be used for a type 3 ambient IoT device. Sequence generation for ambient IoT devices, when same sequence of length 7 used is for type 1 and type 2 ambient IoT device categories and a different sequence of length 7 is used for type 3, then sequence can be generated as shown in the following equation. Note that from ambient IoT device perspective, it may check one synchronization signal sequence depending on its type.

$$synchronization signal ( n ) = 1 - 2 x ( m ) \\ m = ( n + 4 {N}_{ID}^{type} ) mod 7 \\ 0 \leq n < 7 \\ {N}_{ID}^{type} = 0 , 1 ( 0 = type 1 / 2 , 1 = type 3 ) \\ x ( i + 3 ) = ( x ( i + 1 ) + x ( i ) ) mod 2 \\ [ \begin{matrix}x ( 2 ) & x ( 1 ) & x ( 0 )\end{matrix} ] = [ \begin{matrix}1 & 1 & 1\end{matrix} ]$$

Similarly, in another embodiment of the present disclosure, the same synchronization signal sequence with a length of 15 bits can be used for type 1 and type 2 ambient IoT device categories and a different synchronization signal sequence with a length of 15 bits can be used for a type 3 ambient IoT device. Sequence generation for ambient IoT devices, when same sequence of length 15 used is for type 1 and type 2 ambient IoT device categories and a different sequence of length 15 is used for type 3, then sequence can be generated as:

$$synchronization signal ( n ) = 1 - 2 x ( m ) \\ m = ( n + 8 {N}_{ID}^{type} ) mod 15 \\ 0 \leq n < 15 \\ {N}_{ID}^{type} = 0 , 1 ( 0 = type 1 / 2 , 1 = type 3 ) \\ x ( i + 4 ) = ( x ( i + 2 ) + x ( i ) ) mod 2 \\ [ \begin{matrix}x ( 3 ) & x ( 2 ) & x ( 1 ) & x ( 0 )\end{matrix} ] = [ \begin{matrix}1 & 1 & 0 & 1\end{matrix} ]$$

In another embodiment of the present disclosure, different synchronization signal sequences can be generated for different types/categories of ambient IoT devices. For example, different synchronization signal sequences with a length of 7 bits can be used for type 1, type 2, and type 3 ambient IoT devices. Sequence generation for ambient IoT devices, when different sequences of length 7 used is for type 1, type 2 and type 3, then sequence can be generated as:

$$synchronization signal ( n ) = 1 - 2 x ( m ) \\ m = ( n + 2 {N}_{ID}^{type} ) mod 7 \\ 0 \leq n < 7 \\ {N}_{ID}^{type} = 0 , 1 , 2 ( 0 = type 1 , 1 = type 2 , 2 = type 3 ) \\ x ( i + 3 ) = ( x ( i + 1 ) + x ( i ) ) mod 2 \\ [ \begin{matrix}x ( 2 ) & x ( 1 ) & x ( 0 )\end{matrix} ] = [ \begin{matrix}1 & 1 & 1\end{matrix} ]$$

In another embodiment of the present disclosure, different synchronization signal sequences with a length of 15 bits can be used for different types/categories of ambient IoT devices. For example, different synchronization signal sequences with a length of 15 bits can be used for type 1, type 2, and type 3 ambient IoT devices. Sequence generation for ambient IoT devices, when different sequences of length 15 used is for type 1, type 2 and type 3, then sequence can be generated as:

$$synchronization signal ( n ) = 1 - 2 x ( m ) \\ m = ( n + 6 {N}_{ID}^{type} ) mod 15 \\ 0 \leq n < 15 \\ {N}_{ID}^{type} = 0 , 1 , 2 ( 0 = type 1 , 1 = type 2 , 2 = type 3 ) \\ x ( i + 4 ) = ( x ( i + 2 ) + x ( i ) ) mod 2 \\ [ \begin{matrix}x ( 3 ) & x ( 2 ) & x ( 1 ) & x ( 0 )\end{matrix} ] = [ \begin{matrix}1 & 1 & 0 & 1\end{matrix} ]$$

In some wireless communication systems, directly applying current SSB designs can be challenging for ambient IoT devices with low complexity and low power criteria. Therefore, embodiments herein consider and propose synchronization signal sequence type, synchronization signal sequence length, synchronization signal sequence mapping, and synchronization signal.

In some embodiments, a synchronization signal for ambient IoT devices can be composed for a gold sequence including a single long sequence mapped over multiple time symbols. In at least one embodiment, a gold sequence can be a binary sequence that can be used for operations such as scrambling codes so as to minimize cross-correlation between various signals in similar frequency bands. In some embodiments, the gold sequence can include a single long sequence that can be mapped over multiple symbols in the time domain.

In at least one embodiment, a synchronization signal for an ambient IoT device can include a gold sequence with a length of 63 bits. In such embodiments, the length of the gold sequence can be mapped to 63 Resource Elements (REs) over 9 symbols, with 7 REs per 1 time symbol

Additionally or alternatively, the synchronization signal for an ambient IoT device can also be configured to include a gold sequence with a length of 127 bits. In such embodiments, the length of the gold sequence can be mapped to 127 REs over 9 symbols in the time domain, with up to 15 REs per 1 time symbol.

In some embodiments of the present disclosure, the synchronization signal can include gold sequences that are mapped modulated with binary phase shift keying (BPSK). BPSK can be defined as the modulation of a carrier signal by shifting the phase 180 degrees in order to denote a binary transmission. This can provide an ambient IoT device with a simple and efficient way to map the gold sequences of a synchronization signal. BPSK can be ideal for ambient IoT devices with low complexity and/or low power consumption criteria.

In some embodiments, the synchronization signal can include gold sequences that can be mapped modulated with amplitude shift keying (ASK). ASK can be defined as another signal modulation technique that can manipulate the amplitude of a carrier signal that can encode binary transmissions. Similar to BPSK, ASK can also provide an ambient IoT device with a simple and efficient way to map the gold sequences present in synchronization signal. ASK can be an ideal method of modulation for ambient IoT devices with low complexity and/or low power consumption criteria.

In various embodiment, different modulation techniques can be beneficial for use in different types or categories of ambient IoT devices. For example, in some embodiments, BPSK can be used for type C and/or type B ambient IoT devices. Conversely, ASK can be used for type A and/or type B ambient IoT devices.

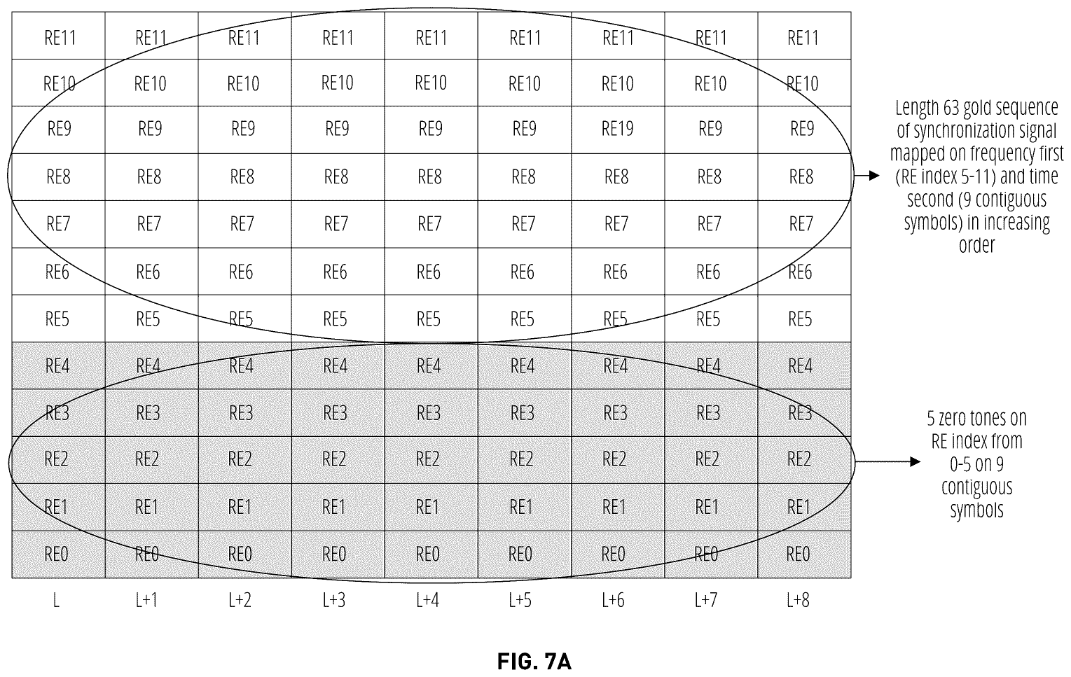

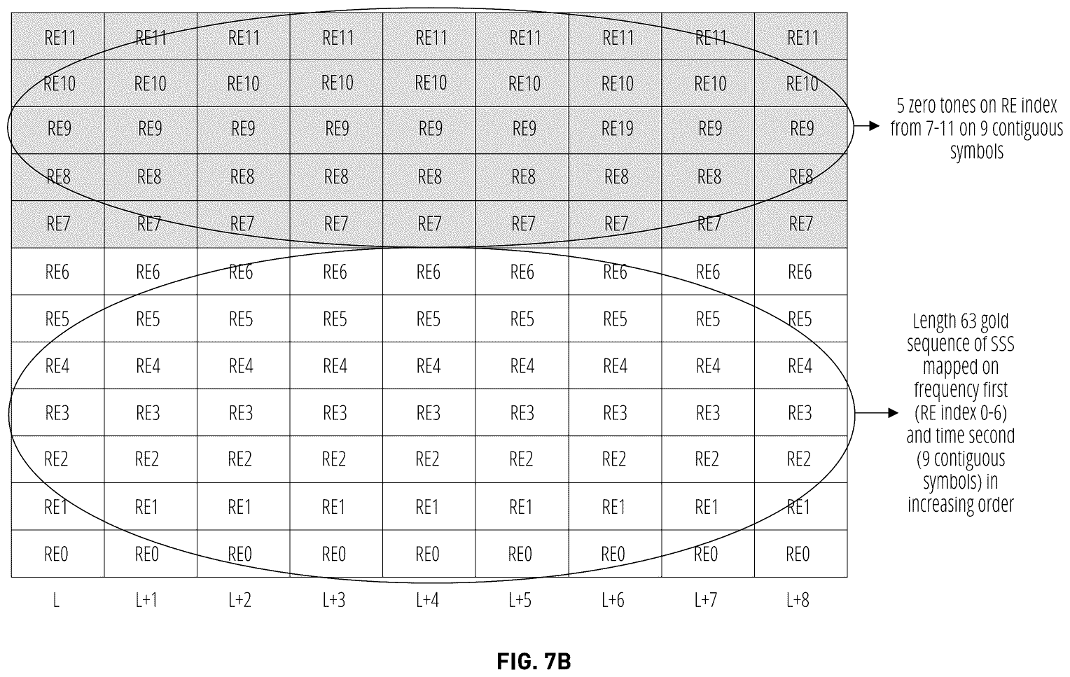

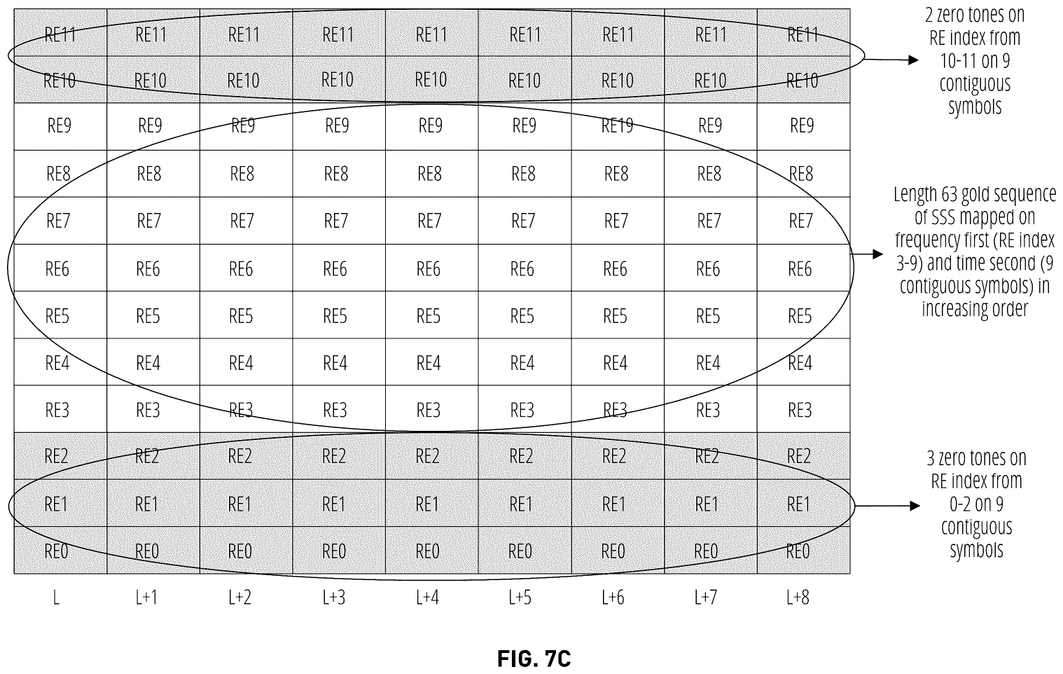

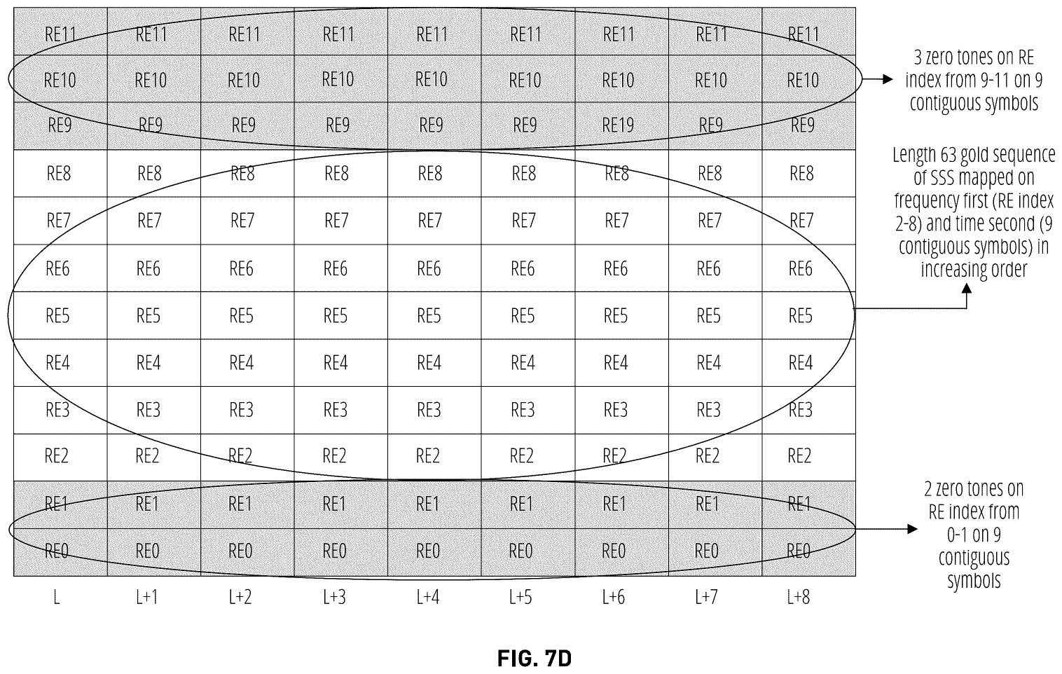

FIG. 7A through FIG. 7D show various examples of synchronization signal patterns in the time domain in accordance with one or more embodiment of the present disclosure. In at least some embodiments, a gold sequence in the synchronization signal can have a length of 63 bits that can extend over multiple symbols in the time domain. In some embodiments, the synchronization signal can be mapped over a single resource block (RB). An RB can be a combination of resource elements (REs) that can hold the data that can constitute the gold sequence.

The REs in the RB where the synchronization signal is mapped can have 5 zero tones per symbol, where a zero tone can be an RE that is not occupied with transmission and/or energy data. For example, there may be no transmission/energy on 5 of the REs and there may be a same mapping over 9 symbols. In some embodiments, the remaining 7 REs per symbol that are not zero tones can be allocated with various data for ambient IoT devices. In at least one embodiment, the remaining REs can be configured to hold the different bits of the gold sequence.

FIG. 7A shows an example of the allocation of gold sequence data and zero tones, in accordance with one or more embodiments of the present disclosure. In this embodiment, REs with indices 0-4 can be configured as zero tones for all 9 contiguous symbols within the synchronization signal. REs with indices 5-11 for each symbol can be populated with gold sequence data. In at least one embodiment, a gold sequence with a length of 63 bits can be allocated to each symbol in the time domain for REs with indices 5-11. In the illustrated embodiment, the first 5 lowest index REs within 1 RB have zero tone.

FIG. 7B shows another example of the allocation of gold sequence data and zero tones in the time domain, in accordance with one or more embodiments of the present disclosure. In this embodiment, REs with indices 7-11 can be configured as zero tones for all 9 contiguous symbols within the RB. REs with indices 0-6 for each symbol can then be populated with gold sequence data. In at least one embodiment, a gold sequence with a length of 63 bits can be allocated to each symbol in the time domain for REs with indices 0-6. In the illustrated embodiment, the last 5 highest index REs within 1 RB have zero tone.

FIG. 7C shows another example of the allocation of gold sequence data and zero tones in the time domain, in accordance with one or more embodiments of the present disclosure. In this embodiment, REs with indices 0-2, 10, and 11 can be configured as zero tones for all 9 contiguous symbols within the RB. REs with indices 3-9 for each symbol can then be populated with gold sequence data. In at least one embodiment, a gold sequence with a length of 63 bits can be allocated to each symbol in the time domain for REs with indices 3-9. In the illustrated embodiment, the first 3 lowest index REs and last 2 highest REs within 1 RB have zero tone.

FIG. 7D shows another example of the allocation of gold sequence data and zero tones in the time domain, in accordance with one or more embodiments of the present disclosure. In this embodiment, REs with indices 0, 1, and 9-11 can be configured as zero tones for all 9 contiguous symbols within the synchronization signal. REs with indices 2-8 for each symbol can then be populated with gold sequence data. In at least one embodiment, a gold sequence with a length of 63 bits can be allocated to each symbol in the time domain for REs with indices 2-8. In the illustrated embodiment, the first 2 lowest index REs and the last 3 highest REs within 1 RB have zero tone.

In some embodiments, a gold sequence with a length of 127 bits can be configured to extend across multiple time symbols, two RBs over which synchronization signal is mapped, may have nine zero tones. For example, there may be no transmission/energy on 9 of the REs for the first 8 time symbols of synchronization signal and for the last time symbol, there are 17 zero tones.

In some embodiments, the first 9 lowest index REs within the first, or lowest, RB can include zero tones for the first 8 symbols. Additionally, the first 17 lowest index REs within the first RB can include zero tones for the last symbol.

In another embodiment, the last 9 highest index REs within the second, or highest, RB can include zero tones for the first 8 symbols where the synchronization signal is mapped. Additionally, the last 17 highest index REs within the second RB can include zero tones for the last symbol.

In yet another embodiment, the first 5 lowest index REs within the first RB and the last 4 highest REs within the second RB can include zero tones for the first 8 symbols where the synchronization signal is mapped. Additionally, the first 9 lowest index REs within the first RB and the last 9 highest REs within the second RB can include zero tones on the last symbol.

In another embodiment, the first 4 lowest index REs within the first RB and the last 5 highest REs within the second highest RB can include zero tones for the first 8 symbols where the synchronization signal is mapped. Additionally, the first 8 lowest index REs within the first RB and the last 8 highest REs within the second RB can include zero tones for the last symbol.

In at least one embodiment of the present disclosure, the number of synchronization signal sequences can vary between different types of ambient IoT devices. In some embodiments, the same synchronization signal sequence can be used for all types and categories of ambient IoT devices. In some embodiments, the same synchronization signal sequence can be used for an ambient IoT device of type A and an ambient IoT device type B, and a different sequence can be used for a type C ambient IoT device. In some embodiments, different synchronization signal sequences can be used for each type of ambient IoT device. For example, 3 different synchronization signal sequences can be used depending on which ambient IoT device is currently applied for use in the communication system.

In some embodiments, the number of symbols over which the synchronization signal sequence is mapped can vary. In some embodiments, the number of symbols over which the synchronization signal sequence is mapped can be fixed in specification for a fixed number of physical cell IDs that can be supported with ambient IoT devices.

In some embodiments, the number of symbols over which the synchronization signal sequence is mapped can depend on the type of ambient IoT device. For example, a type 1 and type 2 ambient IoT device can have the same length and have the same number of physical cell IDs that can be supported, while type 3 ambient IoT can have a different length and support a different number of physical cell IDs. In some embodiments, a type 3 ambient IoT device can support a larger number of symbols than a type 1 or a type 2 ambient IoT device.

In some embodiments, type 1, type 2, and type 3 ambient IoT devices can have different lengths and have different numbers of physical IDs that can be supported. For example, a type 1 ambient IoT device can have a lower number of symbols and can be followed by a type 2 ambient IoT device and then a type 3 ambient IoT device.

In some embodiments, there may be the same number of symbols over which the synchronization signal sequence is mapped, but different sequence lengths can be applied for different device types. For example, a type 1 ambient IoT device can include a sequence length that is shorter than the sequence length used in both type 2 and type 3 ambient IoT devices while still utilizing the same number of symbols.

In some embodiments of the present disclosure, synchronization signal sequences can be generated for various ambient IoT devices. In some embodiments, sequence generation for ambient IoT devices, when same sequence of length 63 used is for all ambient IoT device categories, then sequence can be generated using the following equation. In such embodiments, the synchronization signal sequence can be generated using the following equation where there is one polynomial with 56 cyclic shifts and the other polynomial with 9 cyclic shifts can form 504 different physical cell identifiers (PCIDs). An equation for a gold sequence (e.g., synchronization signal (n)) can be defined as follows, where m0 and m1 are cyclic shifts for the first and second polynomial.

$$synchronization signal ( n ) = [ \text{} 1 - {2}_{{x}_{0}} ( ( n + {m}_{0} ) mod 63 ) ] [ 1 - {2}_{{x}_{1}} ( ( n + {m}_{1} ( mod 63 ) ] \\ {m}_{0} = 5 [ \frac{{N}_{ID}^{( 1 )}}{56} ] , {m}_{1} = {N}_{ID}^{( 1 )} mod 56 \\ 0 \leq n < 63 , {N}_{ID}^{( 1 )} = [ 0 , 1 , 2 , … , 503 ] = Physical Cell ID \\ {x}_{0} ( i + 6 ) = ( {x}_{0} ( i + 3 ) + {x}_{0} ( i ) ) mod 2 , {x}_{1} ( i + 6 ) = ( {x}_{1} ( i + 1 ) + {x}_{1} ( i ) ) mod 2 \\ [ \begin{matrix}{x}_{0} ( 5 ) & {x}_{0} ( 4 ) & {x}_{0} ( 3 ) & {x}_{0} ( 2 ) & {x}_{0} ( 1 ) & {x}_{0} ( 0 ) ]\end{matrix} = [ \begin{matrix}0 & 0 & 0 & 0 & 0 & 1\end{matrix} ] , \\ [ \begin{matrix}{x}_{1} ( 5 ) & {x}_{1} ( 4 ) & {x}_{1} ( 3 ) & {x}_{1} ( 2 ) & {x}_{1} ( 1 ) & {x}_{1} ( 0 ) ]\end{matrix} = [ \begin{matrix}0 & 0 & 0 & 0 & 0 & 1\end{matrix} ]$$

In some embodiments, for sequence generation for ambient IoT devices, when same sequence of length 127 used is for all ambient IoT device categories, then sequence can be generated as using the following equation. There is one polynomial with 112 cyclic shifts and the other polynomial with 9 cyclic shifts can form 1008 different PCIDs. Furthermore, a gold sequence (e.g., synchronization signal (n)) can be defined as follows, where m₀ and m₁ are cyclic shifts for the first and second polynomial.

$$synchronization signal ( n ) = [ \text{} 1 - {2}_{{x}_{0}} ( ( n + {m}_{0} ) mod 127 ) ] [ 1 - {2}_{{x}_{1}} ( ( n + {m}_{1} ( mod 127 ) ] \\ {m}_{0} = 10 [ \frac{{N}_{ID}^{( 1 )}}{112} ] , {m}_{1} = {N}_{ID}^{( 1 )} mod 112 \\ 0 \leq n < 127 , {N}_{ID}^{( 1 )} = [ 0 , 1 , 2 , … , 1007 ] = Physical Cell ID \\ {x}_{0} ( i + 7 ) = ( {x}_{0} ( i + 4 ) + {x}_{0} ( i ) ) mod 2 , {x}_{1} ( i + 7 ) = ( {x}_{1} ( i + 1 ) + {x}_{1} ( i ) ) mod 2 \\ [ \begin{matrix}{x}_{0} ( 6 ) & {x}_{0} ( 5 ) & {x}_{0} ( 4 ) & {x}_{0} ( 3 ) & {x}_{0} ( 2 ) & {x}_{0} ( 1 ) & {x}_{0} ( 0 ) ]\end{matrix} = [ \begin{matrix}0 & 0 & 0 & 0 & 0 & 0 & 1\end{matrix} ] \text{} , \\ [ \begin{matrix}{x}_{1} ( 6 ) & {x}_{1} ( 5 ) & {x}_{1} ( 4 ) & {x}_{1} ( 3 ) & {x}_{1} ( 2 ) & {x}_{1} ( 1 ) & {x}_{1} ( 0 ) ]\end{matrix} = [ \begin{matrix}0 & 0 & 0 & 0 & 0 & 0 & 1\end{matrix} ] \text{}$$

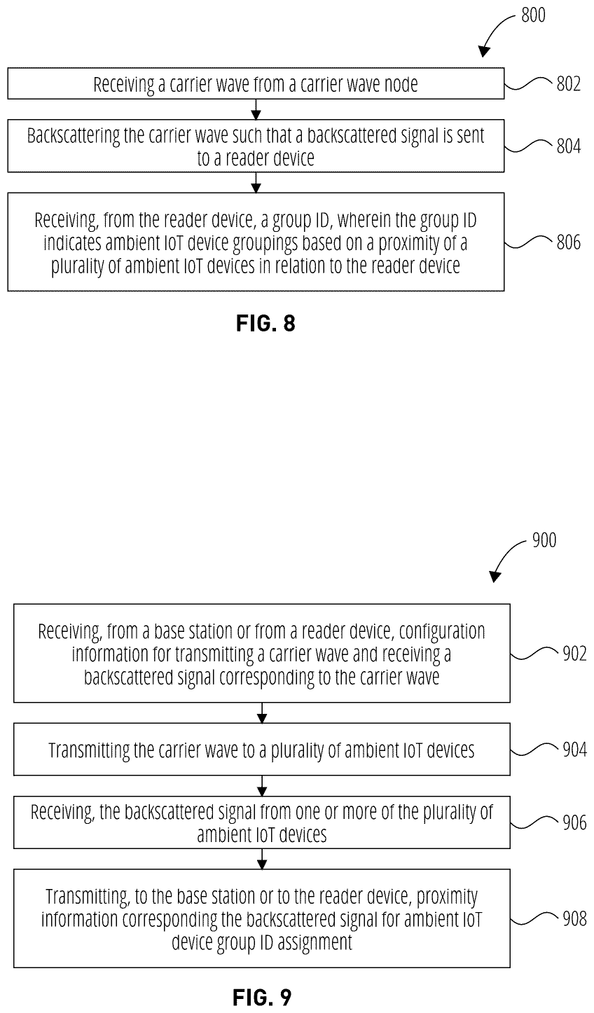

FIG. 8 illustrates a method 800 for an ambient IoT device, according to embodiments herein. The illustrated method 800 includes receiving 802 a carrier wave from a carrier wave node. The method 800 further includes backscattering 804 the carrier wave such that a backscattered signal is sent to the carrier wave node. The method 800 further includes receiving 806, from a reader device, a group ID, wherein the group ID indicates ambient IoT device groupings based on a proximity of a plurality of ambient IoT devices in relation to the reader device.

In some embodiments of the method 800, the carrier wave node comprises an intermediate node.

In some embodiments of the method 800, the carrier wave node comprises an intermediate node. the reader device comprises an intermediate node.

In some embodiments of the method 800, the carrier wave node comprises an intermediate node. the backscattered signal comprises an ID associated with the ambient IoT device.

In some embodiments, the method 800 further comprises communicating with the reader device if the group ID corresponding to one or more of the plurality of the ambient IoT devices is activated.

In some embodiments, the method 800 further comprises modifying the backscattered signal to encode the backscattered signal with an ID associated with the ambient IoT device.

In some embodiments, the method 800 further comprises receiving, from the reader device, an indication to transition to a backscatter mode.

In some embodiments of the method 800, the carrier wave node comprises an intermediate node. the carrier wave comprises a pulse waveform, and wherein backscattered signal comprises a shifted pulse waveform.

FIG. 9 illustrates a method 900 for a carrier wave node, according to embodiments herein. The illustrated method 900 includes receiving 902, from a base station or from a reader device, configuration information for transmitting a carrier wave and receiving a backscattered signal corresponding to the carrier wave. The method 900 further includes transmitting 904 the carrier wave to a plurality of ambient IoT devices. The method 900 further includes receiving 906 the backscattered signal from one or more of the plurality of ambient IoT devices. The method 900 further includes transmitting 908, to the base station or to the reader device, proximity information corresponding the backscattered signal for ambient IoT device group ID assignment.

In some embodiments of the method 900, the carrier wave node comprises an intermediate node.

In some embodiments, the method 900 further comprises processing the backscattered signal to generate proximity information, and wherein the proximity information comprises a proximity of a plurality of ambient IoT devices in relation to the reader device. In some such embodiments, processing the backscattered signal further comprises measuring an RTT delay of the backscattered signal.

In some embodiments, the method 900 further comprises transmitting the backscattered signal to the reader device for the ambient IoT device group ID assignment.

In some embodiments of the method 900, the carrier wave comprises a pulse waveform and the backscattered signal comprises a shifted pulse waveform. Some such embodiments further comprise transmitting a position of the carrier wave node to the reader device for end-to-end proximity determination.

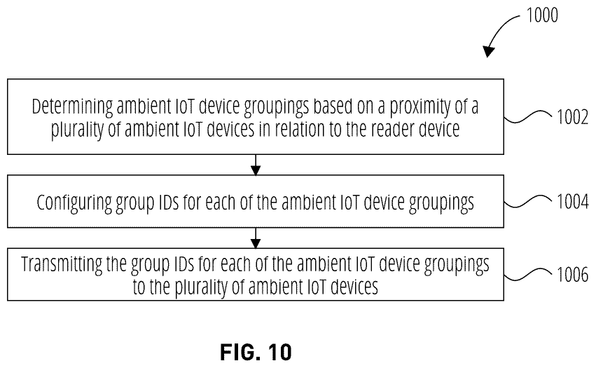

FIG. 10 illustrates a method 1000 for a reader device, according to embodiments herein. The illustrated method 1000 includes determining 1002 ambient IoT device groupings based on a proximity of a plurality of ambient IoT devices in relation to the reader device. The method 1000 further includes configuring 1004 group IDs for each of the ambient IoT device groupings. The method 1000 further includes transmitting 1006 the group IDs for each of the ambient IoT device groupings to the plurality of ambient IoT devices.

In some embodiments of the method 1000, the proximity of the plurality of ambient IoT devices is received from a carrier wave node.

In some embodiments, the method 1000 further comprises transmitting, to a carrier wave node, configuration information for transmitting a carrier wave to and receiving a backscattered signal from the plurality of ambient IoT devices, receiving, from the carrier wave node, a backscattered signal transmitted by the plurality of ambient IoT devices or proximity information, and determining the proximity of the plurality of ambient IoT devices based on the backscattered signal or the proximity information. In some such embodiments, the configuration information configures the carrier wave node to forward the backscattered signal to the reader. In some other such embodiments, determining the proximity of the plurality of ambient IoT devices further comprises accounting for a delay of the carrier wave node.

In some embodiments, the method 1000 further comprises activating one or more of the group IDs, and communicating with the plurality of ambient IoT devices corresponding to the activated one or more group IDs.

In some embodiments, the method 1000 further comprises updating the group IDs based on one or more of a position and movement of the reader device or of the plurality of ambient IoT devices.

In some embodiments, the method 1000 further comprises determining an end-to-end proximity of the plurality of ambient IoT devices based on a proximity of a carrier wave node relative to the reader device.

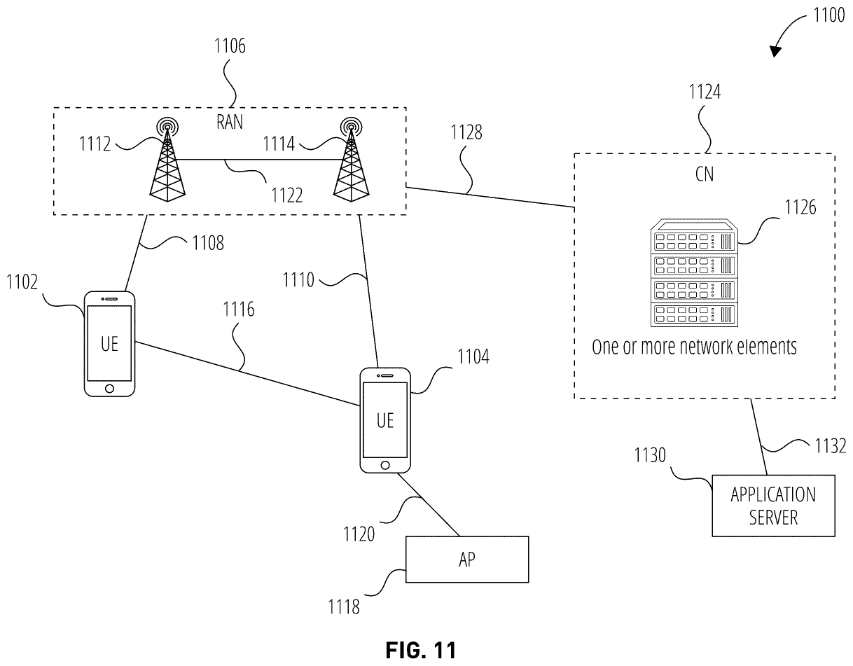

FIG. 11 illustrates an example architecture of a wireless communication system 1100, according to embodiments disclosed herein. The following description is provided for an example wireless communication system 1100 that operates in conjunction with the LTE system standards and/or 5G or NR system standards as provided by 3GPP technical specifications.

As shown by FIG. 11, the wireless communication system 1100 includes UE 1102 and UE 1104 (although any number of UEs may be used). In this example, the UE 1102 and the UE 1104 are illustrated as smartphones (e.g., handheld touchscreen mobile computing devices connectable to one or more cellular networks), but may also comprise any mobile or non-mobile computing device configured for wireless communication.

The UE 1102 and UE 1104 may be configured to communicatively couple with a RAN 1106. In embodiments, the RAN 1106 may be NG-RAN, E-UTRAN, etc. The UE 1102 and UE 1104 utilize connections (or channels) (shown as connection 1108 and connection 1110, respectively) with the RAN 1106, each of which comprises a physical communications interface. The RAN 1106 can include one or more base stations (such as base station 1112 and base station 1114) that enable the connection 1108 and connection 1110.

In this example, the connection 1108 and connection 1110 are air interfaces to enable such communicative coupling, and may be consistent with RAT(s) used by the RAN 1106, such as, for example, an LTE and/or NR.

In some embodiments, the UE 1102 and UE 1104 may also directly exchange communication data via a sidelink interface 1116. The UE 1104 is shown to be configured to access an access point (shown as AP 1118) via connection 1120. By way of example, the connection 1120 can comprise a local wireless connection, such as a connection consistent with any IEEE 802.11 protocol, wherein the AP 1118 may comprise a Wi-Fi® router. In this example, the AP 1118 may be connected to another network (for example, the Internet) without going through a CN 1124.

In embodiments, the UE 1102 and UE 1104 can be configured to communicate using orthogonal frequency division multiplexing (OFDM) communication signals with each other or with the base station 1112 and/or the base station 1114 over a multicarrier communication channel in accordance with various communication techniques, such as, but not limited to, an orthogonal frequency division multiple access (OFDMA) communication technique (e.g., for downlink communications) or a single carrier frequency division multiple access (SC-FDMA) communication technique (e.g., for uplink and ProSe or sidelink communications), although the scope of the embodiments is not limited in this respect. The OFDM signals can comprise a plurality of orthogonal subcarriers.

In some embodiments, all or parts of the base station 1112 or base station 1114 may be implemented as one or more software entities running on server computers as part of a virtual network. In addition, or in other embodiments, the base station 1112 or base station 1114 may be configured to communicate with one another via interface 1122. In embodiments where the wireless communication system 1100 is an LTE system (e.g., when the CN 1124 is an EPC), the interface 1122 may be an X2 interface. The X2 interface may be defined between two or more base stations (e.g., two or more eNBs and the like) that connect to an EPC, and/or between two eNBs connecting to the EPC. In embodiments where the wireless communication system 1100 is an NR system (e.g., when CN 1124 is a 5GC), the interface 1122 may be an Xn interface. The Xn interface is defined between two or more base stations (e.g., two or more gNBs and the like) that connect to 5GC, between a base station 1112 (e.g., a gNB) connecting to 5GC and an eNB, and/or between two eNBs connecting to 5GC (e.g., CN 1124).

The RAN 1106 is shown to be communicatively coupled to the CN 1124. The CN 1124 may comprise one or more network elements 1126, which are configured to offer various data and telecommunications services to customers/subscribers (e.g., users of UE 1102 and UE 1104) who are connected to the CN 1124 via the RAN 1106. The components of the CN 1124 may be implemented in one physical device or separate physical devices including components to read and execute instructions from a machine-readable or computer-readable medium (e.g., a non-transitory machine-readable storage medium).

In embodiments, the CN 1124 may be an EPC, and the RAN 1106 may be connected with the CN 1124 via an S1 interface 1128. In embodiments, the S1 interface 1128 may be split into two parts, an S1 user plane (S1-U) interface, which carries traffic data between the base station 1112 or base station 1114 and a serving gateway (S-GW), and the S1-MME interface, which is a signaling interface between the base station 1112 or base station 1114 and mobility management entities (MMEs).

In embodiments, the CN 1124 may be a 5GC, and the RAN 1106 may be connected with the CN 1124 via an NG interface 1128. In embodiments, the NG interface 1128 may be split into two parts, an NG user plane (NG-U) interface, which carries traffic data between the base station 1112 or base station 1114 and a user plane function (UPF), and the S1 control plane (NG-C) interface, which is a signaling interface between the base station 1112 or base station 1114 and access and mobility management functions (AMFs).

Generally, an application server 1130 may be an element offering applications that use internet protocol (IP) bearer resources with the CN 1124 (e.g., packet switched data services). The application server 1130 can also be configured to support one or more communication services (e.g., VOIP sessions, group communication sessions, etc.) for the UE 1102 and UE 1104 via the CN 1124. The application server 1130 may communicate with the CN 1124 through an IP communications interface 1132.

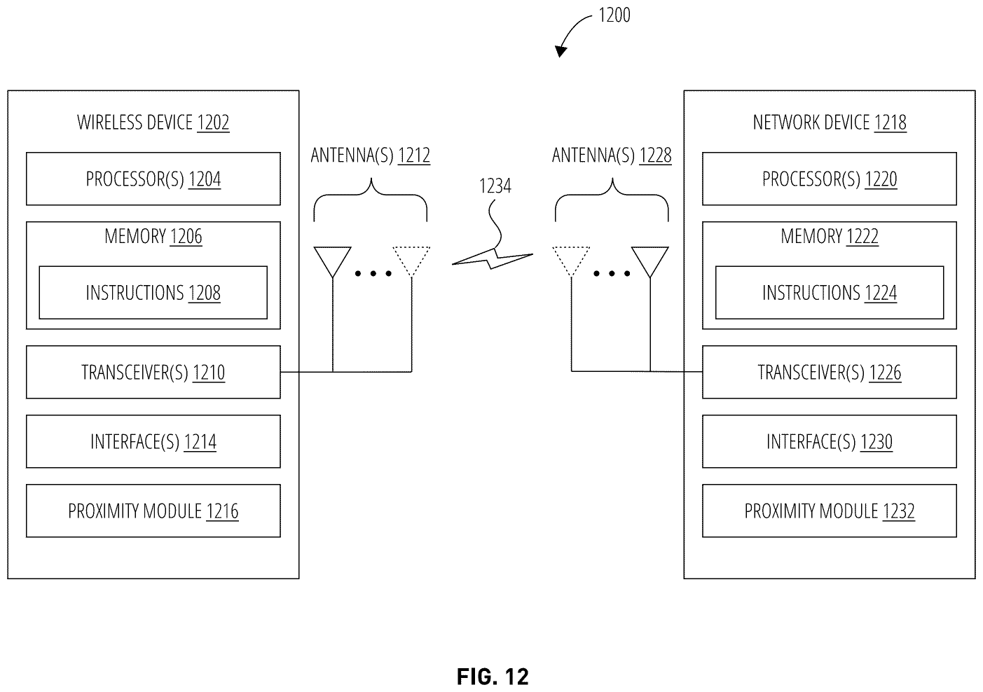

FIG. 12 illustrates a system 1200 for performing signaling 1234 between a wireless device 1202 and a network device 1218, according to embodiments disclosed herein. The system 1200 may be a portion of a wireless communications system as herein described. The wireless device 1202 may be, for example, a UE of a wireless communication system. The network device 1218 may be, for example, a base station (e.g., an eNB or a gNB) of a wireless communication system.

The wireless device 1202 may include one or more processor(s) 1204. The processor(s) 1204 may execute instructions such that various operations of the wireless device 1202 are performed, as described herein. The processor(s) 1204 may include one or more baseband processors implemented using, for example, a central processing unit (CPU), a digital signal processor (DSP), an application specific integrated circuit (ASIC), a controller, a field programmable gate array (FPGA) device, another hardware device, a firmware device, or any combination thereof configured to perform the operations described herein.

The wireless device 1202 may include a memory 1206. The memory 1206 may be a non-transitory computer-readable storage medium that stores instructions 1208 (which may include, for example, the instructions being executed by the processor(s) 1204). The instructions 1208 may also be referred to as program code or a computer program. The memory 1206 may also store data used by, and results computed by, the processor(s) 1204.

The wireless device 1202 may include one or more transceiver(s) 1210 that may include radio frequency (RF) transmitter circuitry and/or receiver circuitry that use the antenna(s) 1212 of the wireless device 1202 to facilitate signaling (e.g., the signaling 1234) to and/or from the wireless device 1202 with other devices (e.g., the network device 1218) according to corresponding RATs.

The wireless device 1202 may include one or more antenna(s) 1212 (e.g., one, two, four, or more). For embodiments with multiple antenna(s) 1212, the wireless device 1202 may leverage the spatial diversity of such multiple antenna(s) 1212 to send and/or receive multiple different data streams on the same time and frequency resources. This behavior may be referred to as, for example, multiple input multiple output (MIMO) behavior (referring to the multiple antennas used at each of a transmitting device and a receiving device that enable this aspect). MIMO transmissions by the wireless device 1202 may be accomplished according to precoding (or digital beamforming) that is applied at the wireless device 1202 that multiplexes the data streams across the antenna(s) 1212 according to known or assumed channel characteristics such that each data stream is received with an appropriate signal strength relative to other streams and at a desired location in the spatial domain (e.g., the location of a receiver associated with that data stream). Certain embodiments may use single user MIMO (SU-MIMO) methods (where the data streams are all directed to a single receiver) and/or multi user MIMO (MU-MIMO) methods (where individual data streams may be directed to individual (different) receivers in different locations in the spatial domain).

In certain embodiments having multiple antennas, the wireless device 1202 may implement analog beamforming techniques, whereby phases of the signals sent by the antenna(s) 1212 are relatively adjusted such that the (joint) transmission of the antenna(s) 1212 can be directed (this is sometimes referred to as beam steering).

The wireless device 1202 may include one or more interface(s) 1214. The interface(s) 1214 may be used to provide input to or output from the wireless device 1202. For example, a wireless device 1202 that is a UE may include interface(s) 1214 such as microphones, speakers, a touchscreen, buttons, and the like in order to allow for input and/or output to the UE by a user of the UE. Other interfaces of such a UE may be made up of transmitters, receivers, and other circuitry (e.g., other than the transceiver(s) 1210/antenna(s) 1212 already described) that allow for communication between the UE and other devices and may operate according to known protocols (e.g., Wi-Fi®, Bluetooth®, and the like).

The wireless device 1202 may include a proximity module 1216. The proximity module 1216 may be implemented via hardware, software, or combinations thereof. For example, the proximity module 1216 may be implemented as a processor, circuit, and/or instructions 1208 stored in the memory 1206 and executed by the processor(s) 1204. In some examples, the proximity module 1216 may be integrated within the processor(s) 1204 and/or the transceiver(s) 1210. For example, the proximity module 1216 may be implemented by a combination of software components (e.g., executed by a DSP or a general processor) and hardware components (e.g., logic gates and circuitry) within the processor(s) 1204 or the transceiver(s) 1210.

The proximity module 1216 may be used for various aspects of the present disclosure, for example, aspects of FIG. 1 through FIG. 11. In some cases, the proximity module 1216 is configured to cause an ambient IoT device to receive a carrier wave from a carrier wave node, backscatter the carrier wave such that a backscattered signal is sent to a reader device, and receive, from the reader device, a group ID, wherein the group ID indicates ambient IoT device groupings based on a proximity of a plurality of ambient IoT devices in relation to the reader device. In some other cases, the proximity module 1216 is configured to cause a carrier wave node to receiving, from a base station or from a reader device, configuration information for transmitting a carrier wave and receiving a backscattered signal corresponding to the carrier wave, transmitting the carrier wave to a plurality of ambient IoT devices, receiving, the backscattered signal from one or more of the plurality of ambient IoT devices, and transmit, to the base station or to the reader device, proximity information corresponding the backscattered signal for ambient IoT device group ID assignment.

The network device 1218 may include one or more processor(s) 1220. The processor(s) 1220 may execute instructions such that various operations of the network device 1218 are performed, as described herein. The processor(s) 1220 may include one or more baseband processors implemented using, for example, a CPU, a DSP, an ASIC, a controller, an FPGA device, another hardware device, a firmware device, or any combination thereof configured to perform the operations described herein.

The network device 1218 may include a memory 1222. The memory 1222 may be a non-transitory computer-readable storage medium that stores instructions 1224 (which may include, for example, the instructions being executed by the processor(s) 1220). The instructions 1224 may also be referred to as program code or a computer program. The memory 1222 may also store data used by, and results computed by, the processor(s) 1220.

The network device 1218 may include one or more transceiver(s) 1226 that may include RF transmitter circuitry and/or receiver circuitry that use the antenna(s) 1228 of the network device 1218 to facilitate signaling (e.g., the signaling 1234) to and/or from the network device 1218 with other devices (e.g., the wireless device 1202) according to corresponding RATs.

The network device 1218 may include one or more antenna(s) 1228 (e.g., one, two, four, or more). In embodiments having multiple antenna(s) 1228, the network device 1218 may perform MIMO, digital beamforming, analog beamforming, beam steering, etc., as has been described.

The network device 1218 may include one or more interface(s) 1230. The interface(s) 1230 may be used to provide input to or output from the network device 1218. For example, a network device 1218 that is a base station may include interface(s) 1230 made up of transmitters, receivers, and other circuitry (e.g., other than the transceiver(s) 1226/antenna(s) 1228 already described) that enables the base station to communicate with other equipment in a core network, and/or that enables the base station to communicate with external networks, computers, databases, and the like for purposes of operations, administration, and maintenance of the base station or other equipment operably connected thereto.

The network device 1218 may include a proximity module 1232. The proximity module 1232 may be implemented via hardware, software, or combinations thereof. For example, the proximity module 1232 may be implemented as a processor, circuit, and/or instructions 1224 stored in the memory 1222 and executed by the processor(s) 1220. In some examples, the proximity module 1232 may be integrated within the processor(s) 1220 and/or the transceiver(s) 1226. For example, the proximity module 1232 may be implemented by a combination of software components (e.g., executed by a DSP or a general processor) and hardware components (e.g., logic gates and circuitry) within the processor(s) 1220 or the transceiver(s) 1226.

The proximity module 1232 may be used for various aspects of the present disclosure, for example, aspects of FIG. 1 through FIG. 11. In some cases, the proximity module 1232 if configured to cause a reader device to determine ambient IoT device groupings based on a proximity of a plurality of ambient IoT devices in relation to the reader device, configure group IDs for each of the ambient IoT device groupings, and transmit the group IDs for each of the ambient IoT device groupings to the plurality of ambient IoT devices.

Embodiments contemplated herein include an apparatus comprising means to perform one or more elements of any of the method 800 and the method 900. This apparatus may be, for example, an apparatus of a UE (such as a wireless device 1202 that is a UE, as described herein).

Embodiments contemplated herein include one or more non-transitory computer-readable media comprising instructions to cause an electronic device, upon execution of the instructions by one or more processors of the electronic device, to perform one or more elements of any of the method 800 and the method 900. This non-transitory computer-readable media may be, for example, a memory of a UE (such as a memory 1206 of a wireless device 1202 that is a UE, as described herein).

Embodiments contemplated herein include an apparatus comprising logic, modules, or circuitry to perform one or more elements of any of the method 800 and the method 900. This apparatus may be, for example, an apparatus of a UE (such as a wireless device 1202 that is a UE, as described herein).

Embodiments contemplated herein include an apparatus comprising: one or more processors and one or more computer-readable media comprising instructions that, when executed by the one or more processors, cause the one or more processors to perform one or more elements of any of the method 800 and the method 900. This apparatus may be, for example, an apparatus of a UE (such as a wireless device 1202 that is a UE, as described herein).

Embodiments contemplated herein include a signal as described in or related to one or more elements of any of the method 800 and the method 900.

Embodiments contemplated herein include a computer program or computer program product comprising instructions, wherein execution of the program by a processor is to cause the processor to carry out one or more elements of any of the method 800 and the method 900. The processor may be a processor of a UE (such as a processor(s) 1204 of a wireless device 1202 that is a UE, as described herein). These instructions may be, for example, located in the processor and/or on a memory of the UE (such as a memory 1206 of a wireless device 1202 that is a UE, as described herein).

Embodiments contemplated herein include an apparatus comprising means to perform one or more elements of the method 1000. This apparatus may be, for example, an apparatus of a base station (such as a network device 1218 that is a base station, as described herein).

Embodiments contemplated herein include one or more non-transitory computer-readable media comprising instructions to cause an electronic device, upon execution of the instructions by one or more processors of the electronic device, to perform one or more elements of the method 1000. This non-transitory computer-readable media may be, for example, a memory of a base station (such as a memory 1222 of a network device 1218 that is a base station, as described herein).

Embodiments contemplated herein include an apparatus comprising logic, modules, or circuitry to perform one or more elements of the method 1000. This apparatus may be, for example, an apparatus of a base station (such as a network device 1218 that is a base station, as described herein).

Embodiments contemplated herein include an apparatus comprising: one or more processors and one or more computer-readable media comprising instructions that, when executed by the one or more processors, cause the one or more processors to perform one or more elements of the method 1000. This apparatus may be, for example, an apparatus of a base station (such as a network device 1218 that is a base station, as described herein).

Embodiments contemplated herein include a signal as described in or related to one or more elements of the method 1000.

Embodiments contemplated herein include a computer program or computer program product comprising instructions, wherein execution of the program by a processing element is to cause the processing element to carry out one or more elements of the method 1000. The processor may be a processor of a base station (such as a processor(s) 1220 of a network device 1218 that is a base station, as described herein). These instructions may be, for example, located in the processor and/or on a memory of the base station (such as a memory 1222 of a network device 1218 that is a base station, as described herein).

For one or more embodiments, at least one of the components set forth in one or more of the preceding figures may be configured to perform one or more operations, techniques, processes, and/or methods as set forth herein. For example, a baseband processor as described herein in connection with one or more of the preceding figures may be configured to operate in accordance with one or more of the examples set forth herein. For another example, circuitry associated with a UE, base station, network element, etc. as described above in connection with one or more of the preceding figures may be configured to operate in accordance with one or more of the examples set forth herein.

Any of the above described embodiments may be combined with any other embodiment (or combination of embodiments), unless explicitly stated otherwise. The foregoing description of one or more implementations provides illustration and description, but is not intended to be exhaustive or to limit the scope of embodiments to the precise form disclosed. Modifications and variations are possible in light of the above teachings or may be acquired from practice of various embodiments.

Embodiments and implementations of the systems and methods described herein may include various operations, which may be embodied in machine-executable instructions to be executed by a computer system. A computer system may include one or more general-purpose or special-purpose computers (or other electronic devices). The computer system may include hardware components that include specific logic for performing the operations or may include a combination of hardware, software, and/or firmware.

It should be recognized that the systems described herein include descriptions of specific embodiments. These embodiments can be combined into single systems, partially combined into other systems, split into multiple systems or divided or combined in other ways. In addition, it is contemplated that parameters, attributes, aspects, etc. of one embodiment can be used in another embodiment. The parameters, attributes, aspects, etc. are merely described in one or more embodiments for clarity, and it is recognized that the parameters, attributes, aspects, etc. can be combined with or substituted for parameters, attributes, aspects, etc. of another embodiment unless specifically disclaimed herein.

It is well understood that the use of personally identifiable information should follow privacy policies and practices that are generally recognized as meeting or exceeding industry or governmental requirements for maintaining the privacy of users. In particular, personally identifiable information data should be managed and handled so as to minimize risks of unintentional or unauthorized access or use, and the nature of authorized use should be clearly indicated to users.

Although the foregoing has been described in some detail for purposes of clarity, it will be apparent that certain changes and modifications may be made without departing from the principles thereof. It should be noted that there are many alternative ways of implementing both the processes and apparatuses described herein. Accordingly, the present embodiments are to be considered illustrative and not restrictive, and the description is not to be limited to the details given herein, but may be modified within the scope and equivalents of the appended claims.

1. A method for an ambient internet of things (IoT) device, the method comprising:
receiving a carrier wave from a carrier wave node;
backscattering the carrier wave such that a backscattered signal is sent to a reader device; and
receiving, from the reader device, a group identifier (ID), wherein the group ID indicates ambient IoT device groupings based on a proximity of a plurality of ambient IoT devices in relation to the reader device.

2. The method of claim 1, wherein the carrier wave node comprises an intermediate node.

3. The method of claim 1, wherein the reader device comprises an intermediate node.

4. The method of claim 1, wherein the backscattered signal comprises an ID associated with the ambient IoT device.

5. The method of claim 1, further comprising communicating with the reader device if the group ID corresponding to one or more of the plurality of the ambient IoT devices is activated.

6. The method of claim 1, further comprising modifying the backscattered signal to encode the backscattered signal with an ID associated with the ambient IoT device.

7. The method of claim 1, further comprising receiving, from the reader device, an indication to transition to a backscatter mode.

8. The method of claim 1, wherein the carrier wave comprises a pulse waveform, and wherein backscattered signal comprises a shifted pulse waveform.

9. A method for a carrier wave node, the method comprising:
receiving, from a base station or from a reader device, configuration information for transmitting a carrier wave and receiving a backscattered signal corresponding to the carrier wave;
transmitting the carrier wave to a plurality of ambient internet of things (IoT) devices;
receiving, the backscattered signal from one or more of the plurality of ambient IoT devices; and
transmitting, to the base station or to the reader device, proximity information corresponding the backscattered signal for ambient IoT device group identifier (ID) assignment.

10. The method of claim 9, wherein the carrier wave node comprises an intermediate node.

11. The method of claim 9, further comprising processing the backscattered signal to generate proximity information, and wherein the proximity information comprises a proximity of a plurality of ambient IoT devices in relation to the reader device.

12. The method of claim 11, wherein processing the backscattered signal further comprises measuring a round trip time (RTT) delay of the backscattered signal.

13. The method of claim 9, further comprising transmitting the backscattered signal to the reader device for the ambient IoT device group ID assignment.

14. The method of claim 9, further comprising transmitting a position of the carrier wave node to the reader device for end-to-end proximity determination.

15. A method for a reader device, the method comprising:
determining ambient internet of things (IoT) device groupings based on a proximity of a plurality of ambient IoT devices in relation to the reader device;
configuring group identifiers (IDs) for each of the ambient IoT device groupings; and
transmitting the group IDs for each of the ambient IoT device groupings to the plurality of ambient IoT devices.

16. The method of claim 15, further comprising:
transmitting, to a carrier wave node, configuration information for transmitting a carrier wave to and receiving a backscattered signal from the plurality of ambient IoT devices;
receiving, from the carrier wave node, a backscattered signal transmitted by the plurality of ambient IoT devices or proximity information; and
determining the proximity of the plurality of ambient IoT devices based on the backscattered signal or the proximity information.

17. The method of claim 16, wherein determining the proximity of the plurality of ambient IoT devices further comprises accounting for a delay of the carrier wave node.

18. The method of claim 15, further comprising:
activating one or more of the group IDs; and
communicating with the plurality of ambient IoT devices corresponding to the activated one or more group IDs.

19. The method of claim 15, further comprising updating the group IDs based on one or more of a position and movement of the reader device or of the plurality of ambient IoT devices.

20. The method of claim 15, further comprising determining an end-to-end proximity of the plurality of ambient IoT devices based on a proximity of a carrier wave node relative to the reader device.
